(19) United States
(12) Patent Application Publication
(10) Pub. No.: US 2011/0114059 A1
(43) Pub. Date: May 19, 2011

(54) METHODS OF OPTIMIZING COMBUSTION IN A COMBUSTION CHAMBER

(75) Inventor: Alejandro Hernan Plazas Torres, Rochester Hills, MI (US)

(73) Assignee: GM GLOBAL TECHNOLOGY OPERATIONS, INC., Detroit, MI (US)

(21) Appl. No.: 12/619,763

(22) Filed: Nov. 17, 2009

(51) Int. Cl. F02B 5/00; F02M 69/04; F02D 41/30

(52) U.S. Cl. 123/305; 123/445; 701/103

(57) ABSTRACT

A method of optimizing combustion in a combustion chamber during operation of a fuel-injected internal combustion engine includes monitoring an operating condition of the internal combustion engine, and adjusting a protrusion depth of a fuel injector nozzle in the combustion chamber according to the operating condition to thereby optimize combustion in the combustion chamber. A fuel injector system includes a fuel injector configured for injecting fuel into the combustion chamber and an actuator. The fuel injector includes a body and the fuel injector nozzle slideably connected to the body and configured for translating within and injecting a fuel plume into the combustion chamber. The actuator is configured for adjusting the fuel injector nozzle within the combustion chamber. A shape of the fuel plume remains substantially unchanged as the fuel injector nozzle translates within the combustion chamber.

### TECHNICAL FIELD

The present invention generally relates to fuel injection of an internal combustion engine, and more specifically, to optimizing combustion in a combustion chamber of the internal combustion engine.

### BACKGROUND OF THE INVENTION

Fuel injectors are useful for maintaining a balanced air-to-fuel ratio during operation of an internal combustion engine. A balanced air-to-fuel ratio minimizes engine emissions such as unburned hydrocarbons and carbon monoxide, and ensures proper engine functioning and economical fuel consumption.

In particular, a fuel injector typically injects a pressurized fuel plume at a precise spray target of a combustion chamber of the internal combustion engine. Careful control of the spray target may optimize combustion. However, existing methods of controlling the spray target are often only tailored for one engine operating condition, e.g., peak power, and are therefore less effective across an entire range of engine operating conditions, e.g., at low engine speeds or loads.

### SUMMARY OF THE INVENTION

A method of optimizing combustion in a combustion chamber during operation of a fuel-injected internal combustion engine includes monitoring an operating condition of the internal combustion engine, and adjusting a protrusion depth of a fuel injector nozzle in the combustion chamber according to the operating condition to thereby optimize combustion in the combustion chamber.

A method of optimizing combustion in a combustion chamber during operation of a fuel-injected internal combustion engine includes monitoring an operating condition of the internal combustion engine, selecting a protrusion depth of a fuel injector nozzle in the combustion chamber according to the operating condition, and positioning the fuel injector nozzle at the protrusion depth to thereby optimize combustion in the combustion chamber. The fuel injector nozzle and a piston of the internal combustion engine each do not substantially move relative to the other during combustion.

A fuel injector system includes a fuel injector and an actuator. The fuel injector is configured for injecting fuel into a combustion chamber of an internal combustion engine, and includes a body and a fuel injector nozzle slideably connected to the body. The fuel injector nozzle is configured for translating within and injecting a fuel plume into the combustion chamber. Further, the actuator is configured for adjusting the fuel injector nozzle within the combustion chamber. A shape of the fuel plume remains substantially unchanged as the fuel injector nozzle translates within the combustion chamber.

The methods and system allow for precise control of the protrusion depth of the fuel injector nozzle during operation of the internal combustion engine and consequently optimize combustion. Therefore, the methods and system provide excellent engine performance, minimize fuel consumption, and minimize engine emissions. Moreover, the methods provide the aforementioned benefits across an entire range of engine operating conditions, e.g., low engine load and/or low engine speed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a cross-sectional view of an illustration of a portion of an exemplary combustion chamber of an internal combustion engine that includes a fixed fuel injector nozzle of the prior art;

FIG. 2 is a schematic cross-sectional view of a fuel injector system including a fuel injector and an actuator; and

FIG. 3 is a schematic cross-sectional view of a portion of the fuel injector nozzle of FIG. 2 disposed in a plurality of positions within a combustion chamber.

### DESCRIPTION OF THE PREFERRED EMBODIMENTS

Referring to the drawings, wherein like reference numerals refer to like elements, a fuel injector system is shown generally at 10 in FIG. 2. The fuel injector system 10 and methods disclosed herein may be useful for applications requiring a fuel-injected internal combustion engine. For example, the fuel injector system 10 may be useful for automotive applications including diesel or gasoline internal combustion engines with common rail fuel injection and/or electronic fuel injection. However, it is to be appreciated that the fuel injector system 10 and methods may be useful for non-automotive applications, such as, but not limited to, marine, rail, and aviation applications.

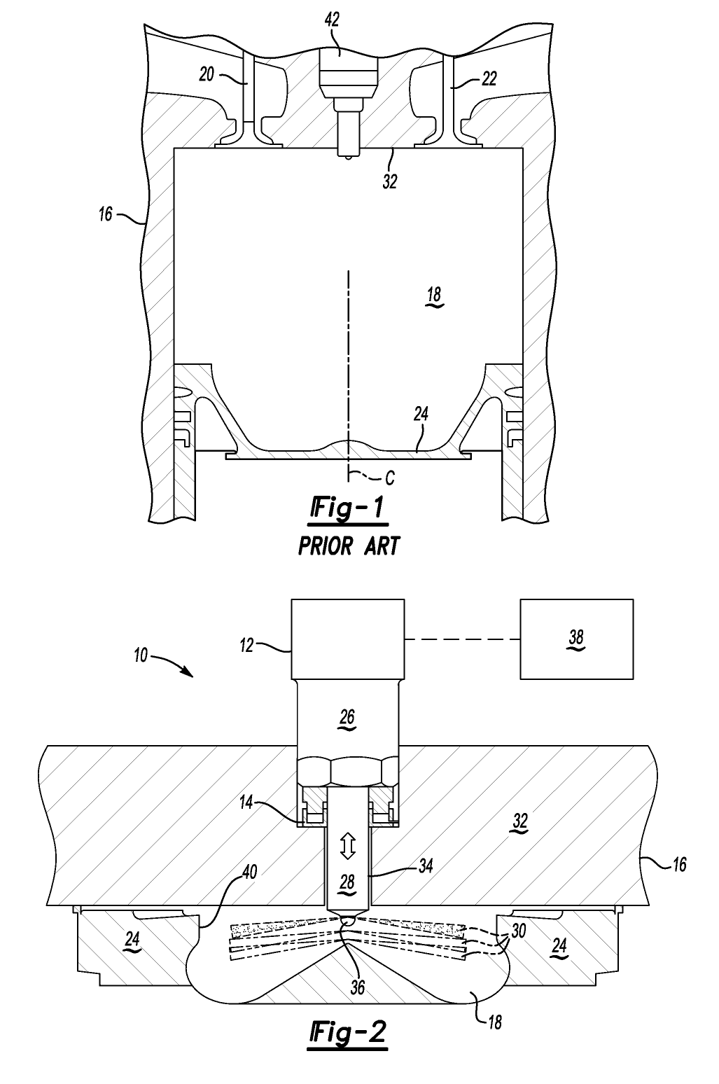

Referring to FIG. 2, the fuel injector system 10 includes a fuel injector 12 and an actuator 14. By way of general background explanation, and with reference to FIG. 1, an internal combustion engine 16 may include a combustion chamber 18 configured for igniting a mixture of air and fuel during engine operation. The combustion chamber 18 may include an intake valve 20 and an exhaust valve 22 and may be suitably configured for housing a piston 24. The piston 24 may be slideably disposed within the combustion chamber 18 and may translate along a central vertical axis C of the combustion chamber 18 during operation of the fuel-injected internal combustion engine 16. In one example, the internal combustion engine 16 may be a diesel engine.

Referring again to FIG. 2, the fuel injector 12 is configured for injecting fuel into the combustion chamber 18 of the internal combustion engine 16. In particular, the fuel injector 12 includes a body 26 and a fuel injector nozzle 28. The body 26 of the fuel injector 12 may be any shape suitable for containing and delivering fuel from a fuel line (not shown). For example, the body 26 may be a hollow cylinder.

Referring to FIG. 2, the fuel injector nozzle 28 is slideably connected to the body 26 and is configured for translating within and injecting a fuel plume 30 into the combustion chamber 18. For example, the fuel injector nozzle 28 may be slideably disposed within the body 26 of the fuel injector 12 so as to be configured for withdrawing into and/or extending from the body 26. That is, the fuel injector nozzle 28 is separate and distinct from the body 26 of the fuel injector 12. Therefore, although the body 26 may be fixedly attached to a head deck 32 (FIGS. 1 and 2) of the internal combustion engine 16, the fuel injector nozzle 28 is configured for translating within the combustion chamber 18, as set forth in more detail below. The fuel injector nozzle 28 may have any suitable shape. However, it is to be appreciated that the size and/or shape of the fuel injector nozzle 28 may be determined by the size and/or shape of the body 26 of the fuel injector 12.

Referring to FIG. 2, the fuel plume 30 may exit a distal end 34 of the fuel injector nozzle 28 via an orifice 36, e.g., a spray tip. That is, the fuel injector nozzle 28 may atomize the fuel so as to provide the fuel plume 30 in the combustion chamber 18. As known in the art, a skilled artisan may select the size, shape, orientation, and/or length of the fuel plume 30 according to desired engine performance characteristics.

As shown generally in FIG. 2, the actuator 14 is configured for adjusting the fuel injector nozzle 28 within the combustion chamber 18, as set forth in more detail below. The actuator 14 may be any suitable actuator known in the art. For example, the actuator 14 may be selected from the group of hydraulic actuators, pneumatic actuators, cam-spring actuators, piezoelectric actuators, and combinations thereof. In one example, the actuator 14 may respond to a hydraulic signal based on fuel or oil pressure. That is, the actuator 14 may be a hydraulic lifter.

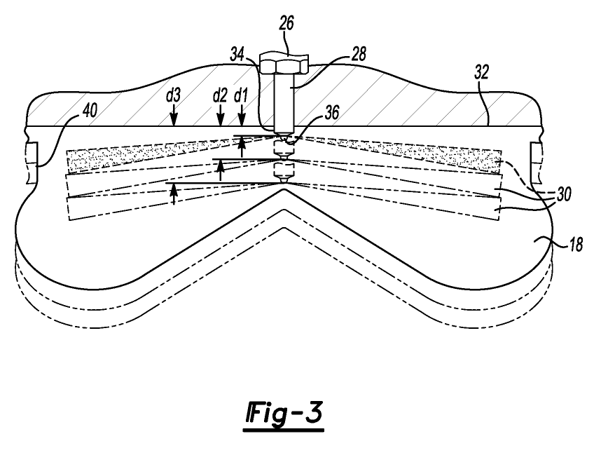

As set forth above, the fuel injector nozzle 28 is configured for translating within the combustion chamber 18. That is, referring to FIG. 3, the fuel injector nozzle 28 may inject the fuel plume 30 into the combustion chamber 18 at a plurality of selectable protrusion depths d₍₁₋₃₎, as set forth in more detail below. As used herein, the terminology “protrusion depth” refers to a distance from the head deck 32 of the internal combustion engine 16 to the orifice 36 of the fuel injector nozzle 28. That is, the terminology “protrusion depth” generally refers to how far the fuel injector nozzle 28 protrudes into the combustion chamber 18. Notably, a shape of the fuel plume 30 remains substantially unchanged as the fuel injector nozzle 28 translates within the combustion chamber 18, as also set forth in more detail below.

A method of optimizing combustion in the combustion chamber 18 during operation of the fuel-injected internal combustion engine 16 includes monitoring an operating condition of the internal combustion engine 16. For example, an operating condition such as, but not limited to, engine load, engine speed, fuel pressure, fuel temperature, air-to-fuel ratio in the combustion chamber 18, engine temperature, transmission parameters, and combinations thereof may be monitored. In one specific example, engine load and/or engine speed may be monitored.

Referring to FIG. 2, the operating condition may be monitored by an electronic control module 38. The electronic control module 38 may be any device or devices suitable for data input, storage, processing, and output. For example, the electronic control module 38 may be a vehicle computer, a computer program, or an engine control unit (ECU). Further, although not shown in FIG. 2 but known in the art, the electronic control module 38 may electronically connect a plurality of systems, sensors, and devices necessary for monitoring engine conditions, such as, but not limited to, oxygen, temperature, and speed sensors.

The method also includes adjusting a protrusion depth d₍₁₋₃₎ of the fuel injector nozzle 28 in the combustion chamber 18 according to the operating condition to thereby optimize combustion in the combustion chamber. As set forth above, the fuel injector nozzle 28 may be adjusted by the actuator 14 (FIG. 2). For example, adjusting may translate the fuel injector nozzle 28 within the combustion chamber 18.

Referring generally to FIGS. 1 and 2, it is to be appreciated that the fuel injector nozzle 28 may translate along any axis of the combustion chamber 18. For example, the fuel injector nozzle 28 may translate along the central vertical axis C of the combustion chamber 18. However, the fuel injector nozzle 28 may alternatively translate along an axis that intersects the central vertical axis C of the combustion chamber 18. For example, although not shown by the Figures, the fuel injector nozzle 28 may protrude into the combustion chamber 18 at an angle.

Referring to FIG. 2, in this embodiment, the fuel injector nozzle 28 and a piston 24 of the internal combustion engine 16 may each move relative to the other within the combustion chamber 18 during combustion. That is, a distance between the fuel injector nozzle 28 and the piston 24 may vary during combustion. For example, the fuel injector nozzle 28 may be adjusted to the selected protrusion depth d₍₁₋₃₎ (FIG. 3) for a given engine load and/or engine speed and fixed in position during combustion. Stated differently, in this embodiment, there may be relative motion between the piston 24 and the fuel injector nozzle 28. However, to optimize engine performance and minimize breakdown of the internal combustion engine 16, it is to be appreciated that the fuel injector nozzle 28 may not contact the piston 24.

Referring to FIGS. 2 and 3, the shape of the injected fuel plume 30 may remain substantially unchanged as the fuel injector nozzle 28 translates within the combustion chamber 18. That is, the shape of the injected fuel plume 30 may not be modified by impingement. For example, the injected fuel plume 30 may not impinge a surface 40 of the combustion chamber 18. Further, the injected fuel plume 30 may not impinge another component of the fuel injector nozzle 28, e.g., a baffle (not shown) or a sleeve (not shown). Stated differently, the shape of the injected fuel plume 30 may not be modified by striking, dashing, and/or colliding with any surface 40. Rather, as set forth above, the injected fuel plume 30 may exit the distal end 34 of the fuel injector nozzle 28 according to the desired shape of the fuel plume 30 as determined by any orifices 36 of the fuel injector nozzle 28. Since the injected fuel plume 30 may not impinge any surface 40 during adjusting, the shape of the injected fuel plume 30 may remain substantially unchanged at each protrusion depth d₍₁₋₃₎. Therefore, a spray target of the combustion chamber 18 may be precisely controlled without changing the shape of the fuel plume 30. Consequently, by adjusting the fuel injector nozzle 28 to the protrusion depth d₍₁₋₃₎, the injected fuel plume 30 may precisely remain within the spray target of the combustion chamber 18. By comparison, for example, changing a length or a shape of the fuel plume 30 may afford less control of the spray target.

Referring now to FIG. 3, in another embodiment, a method of optimizing combustion in the combustion chamber 18 of the fuel-injected internal combustion engine 16 includes monitoring the operating condition of the internal combustion engine 16 as set forth above. The method further includes selecting the protrusion depth d₍₁₋₃₎ of the fuel injector nozzle 28 in the combustion chamber 18 according to the operating condition. That is, the optimal and/or desired protrusion depth d₍₁₋₃₎ for each operating condition, e.g., for each engine speed and/or engine load, may be stored and/or selected via the electronic control module 38. For example, referring to FIG. 3, for an engine speed of less than or equal to about 2,000 revolutions per minute (rpm), the desired protrusion depth d₃ of the fuel injector nozzle 28 may be larger than the desired protrusion depth d₁ for an engine speed of about 5,500 rpm.

Additionally, the method includes positioning the fuel injector nozzle 28 at the protrusion depth d₍₁₋₃₎ to thereby optimize combustion in the combustion chamber 18. For example, the fuel injector nozzle 28 may be positioned by the actuator 14, as set forth above, so that the fuel injector nozzle 28 may translate within the combustion chamber 18.

However, for the method, the fuel injector nozzle 28 and the piston 24 of the internal combustion engine 16 each do not substantially move relative to the other. That is, a distance between the fuel injector nozzle 28 and the piston 24 may remain substantially unchanged during combustion. For example, the fuel injector nozzle 28 may be positioned to the selected protrusion depth d₍₁₋₃₎ for each given engine load and/or engine speed and continuously change position during combustion according to a position of the piston 24. Stated differently, in this embodiment, there may be no relative motion between the piston 24 and the fuel injector nozzle 28 so that the spray target is fixed.

Referring to FIG. 3, for this embodiment, the shape of the injected fuel plume 30 may also remain substantially unchanged as the fuel injector nozzle 28 translates within the combustion chamber 18. That is, the shape of the injected fuel plume 30 may not be modified by impingement. For example, the injected fuel plume 30 may not impinge the surface 40 of the combustion chamber 18. Further, the injected fuel plume 30 may not impinge another component of the fuel injector nozzle 28, e.g., a baffle (not shown) or a sleeve (not shown). Stated differently, the shape of the injected fuel plume 30 may not be modified by striking, dashing, and/or colliding with any surface 40. Rather, as set forth above, the injected fuel plume 30 exits the distal end 34 of the fuel injector nozzle 28 according to the desired shape of the fuel plume 30 as determined by any orifices 36 of the fuel injector nozzle 28. Since the injected fuel plume 30 may not impinge any surface 40 during positioning, the shape of the injected fuel plume 30 may remain substantially unchanged at each selected protrusion depth d₍₁₋₃₎. Therefore, a spray target of the combustion chamber 18 may be precisely controlled without changing a shape of the fuel plume 30.

As compared to the prior art fuel injector 42 of FIG. 1 that is fixed and does not translate within the combustion chamber 18, the methods and system set forth above allow for excellent control and precise fuel injection for an internal combustion engine 16. More specifically, the methods and system allow for precise control of the protrusion depth d₍₁₋₃₎ of the fuel injector nozzle 28 during operation of the internal combustion engine 16. Such precise control allows for an optimized air-to-fuel ratio in the combustion chamber 18 and minimizes problems associated with rich or lean air-to-fuel mixtures. Therefore, the methods and system provide excellent engine performance, minimize fuel consumption, and minimize engine emissions such as unburned hydrocarbons and soot. Further, the methods provide the aforementioned benefits across an entire range of engine operating conditions, e.g., low engine load and/or low engine speed and provide flexibility for the design of combustion modes.

While the best modes for carrying out the invention have been described in detail, those familiar with the art to which this invention relates will recognize various alternative designs and embodiments for practicing the invention within the scope of the appended claims.

1. A method of optimizing combustion in a combustion chamber during operation of a fuel-injected internal combustion engine, the method comprising the steps of:
monitoring an operating condition of the internal combustion engine; and
adjusting a protrusion depth of a fuel injector nozzle in the combustion chamber according to the operating condition to thereby optimize combustion in the combustion chamber.

2. The method of claim 1, wherein adjusting translates the fuel injector nozzle within the combustion chamber.

3. The method of claim 1, wherein the fuel injector nozzle and a piston of the internal combustion engine each move relative to the other within the combustion chamber during combustion.

4. The method of claim 3, wherein the fuel injector nozzle does not contact the piston.

5. The method of claim 2, wherein a shape of an injected fuel plume remains substantially unchanged as the fuel injector nozzle translates within the combustion chamber.

6. The method of claim 5, wherein the shape of the injected fuel plume is not modified by impingement.

7. The method of claim 6, wherein the injected fuel plume does not impinge a surface of the combustion chamber.

8. The method of claim 1, wherein the fuel injector nozzle is adjusted via an actuator.

9. The method of claim 8, wherein the actuator is selected from the group of hydraulic actuators, pneumatic actuators, cam-spring actuators, piezoelectric actuators, and combinations thereof.

10. The method of claim 1, wherein the operating condition is selected from the group of engine load, engine speed, and combinations thereof.

11. The method of claim 1, wherein the operating condition is monitored via an electronic control module.

12. The method of claim 11, wherein the protrusion depth is selected via the electronic control module.

13. A method of optimizing combustion in a combustion chamber during operation of a fuel-injected internal combustion engine, the method comprising the steps of:
monitoring an operating condition of the internal combustion engine;
selecting a protrusion depth of a fuel injector nozzle in the combustion chamber according to the operating condition; and
positioning the fuel injector nozzle at the protrusion depth to thereby optimize combustion in the combustion chamber;
wherein the fuel injector nozzle and a piston of the internal combustion engine each do not substantially move relative to the other during combustion.

14. The method of claim 13, wherein a distance between the fuel injector nozzle and the piston remains substantially unchanged during combustion.

15. The method of claim 13, wherein positioning translates the fuel injector nozzle within the combustion chamber.

16. The method of claim 15, wherein a shape of an injected fuel plume remains substantially unchanged as the fuel injector nozzle translates within the combustion chamber.

17. A fuel injector system comprising:
a fuel injector configured for injecting fuel into a combustion chamber of an internal combustion engine and including;
a body; and
a fuel injector nozzle slideably connected to said body and configured for translating within and injecting a fuel plume into the combustion chamber; and
an actuator configured for adjusting said fuel injector nozzle within the combustion chamber;
wherein a shape of the fuel plume remains substantially unchanged as said fuel injector nozzle translates within the combustion chamber.

18. The fuel injector system of claim 17, wherein said actuator is selected from the group of hydraulic actuators, pneumatic actuators, cam-spring actuators, piezoelectric actuators, and combinations thereof.

19. The fuel injector system of claim 17, wherein the internal combustion engine is a diesel engine.
